(19) United States
(12) Patent Application Publication
(10) Pub. No.: US 2008/0104579 A1
(43) Pub. Date: May 1, 2008

(54) Systems and methods of transforming XML schemas

(75) Inventor: Falk Hartmann, Dresden (DE)

Correspondence Address: Fountainhead Law Group P.C., 900 LAFAYETTE STREET, SUITE 509, SANTA CLARA, CA, 95050, US

(73) Assignee: SAP AG, Walldorf (DE)

(21) Appl. No.: 11/590,330

(22) Filed: Oct. 31, 2006

(51) Int. Cl. G06F 9/45; G06F 17/00

(52) U.S. Cl. 717/136; 715/234; 715/239

(57) ABSTRACT

Embodiments of the present invention provide systems and methods of transforming XML schemas. One embodiment the present invention includes a computer-implemented method of translating schemas comprising specifying one or more first schema elements in a first schema, specifying one or more operations corresponding to the one or more first schema elements, selecting the one or more first schema elements, and transforming each of the one or more first schema elements into one or more second schema elements of a second schema based on the specified operations.

### BACKGROUND

The present invention relates to translating XML schemas, and in particular, to translating XML schemas into new XML schemas using a schema translation specification.

A markup language is a system for managing information and is used to code the information in a document by adding structure and metadata (i.e., information about data) to the document. Extensible Markup Language (XML) is a widely used markup language, which is designed to better handle the task of managing information. XML is more like a meta-language, which provides the grammar for developing custom markup languages, each with its own vocabulary. XML describes a syntax which can be used to create different languages. XML is a text-based language that can be used to mark up data (i.e., add metadata) in a way that is self-describing. Accordingly, XML may be used to define specific languages or particular instances of the languages. An example of an XML language specification is XML Schema (also referred to as XSD). Particular instances of an XML schema language are referred to as XML schemas, which typically have a file extension of “.xsd.” Particular instances of an XML schema are referred to as an XML document and typically have a file extension of “.xml.” XML documents for a particular XML schema will conform to the XML schema (i.e., the XML documents will represent information in conformity with the rules specified by the XML schema). Both an XML schema and an XML document conforming to the XML schema may be represented using XML.

For any particular XML schema language, a variety of XML schemas may be defined. XML languages are more generally referred to as “schema languages.” Other schema languages include DTD and RelaxNG, for example. A variety of XML documents may be implemented conforming to any schema specified using a particular schema language. Because both a schema and documents conforming to the schema may be represented using XML, a hierarchy between the various constructs may be established. The XML hierarchy is an incarnation of the Object Management Group (“OMG”) and Meta-Object Facility (“MOF”) four layer specification. For example, if a particular XML schema is used to describe cars, then a specific car description, “Car.xml” 110, would belong to the level M0 of the four layer specification. The XML schema describing the cars, “Cars.xsd” 111, would belong to level M1. The XML schema language, “XSD.xsd” 112, describing the XML schema for describing cars would belong to level M2 of the four layer specification.

Traditionally, it has been desirable to transform XML documents (.xml) that conform to one schema into XML documents that conform to another schema (i.e., document-to-document translation). To transform XML documents, an established technology named XSLT (Extensible Stylesheet Language—Transformations) exists. This is an XML language that may be used to define how a source XML document can be transformed into a target XML document using a set of transformation rules (which are, basically, pairs of patterns matched against the source document with fragments that are aggregated to yield the target document). An example of this process is illustrated in FIG. 1. An XML schema (A.xsd) software file 101 may be used to specify a particular schema. XML schema 101 is an instance of a particular XML schema language. A particular instance of the XML schema 101 may be an XML document (B.xml) 102. XSLT 103 may specify the transformation necessary for transforming B.xml into another XML document (C.xml) 104 that conforms to another XML schema (D.xsd) 105.

As the use of XML documents becomes more widespread, the number of schemas used to describe such documents is ever increasing. Moreover, schemas languages tend to evolve, and may have multiple versions that may be similar, and may need to be maintained and documented. In many cases it may be desirable to create new schemas from preexisting schemas automatically if the schema languages change. For example, in developing a schema “S” based on XHTML2, where XHTML2 may be a new standard changing over time with multiple versions publishes over time, a developer currently must recreate “S” based on the newly released versions of the underlying language. There is currently no effective mechanism for translating XML schemas into new XML schemas.

Thus, there is a need for systems and methods of translating XML schemas. The present invention solves these and other problems by providing systems and methods of translating XML schemas.

### SUMMARY

Embodiments of the present invention provide systems and methods of translating XML schemas. One embodiment the present invention includes a computer-implemented method of translating schemas comprising specifying one or more first schema elements in a first schema, specifying one or more operations corresponding to the one or more first schema elements, selecting the one or more first schema elements, and transforming each of the one or more first schema elements into one or more second schema elements of a second schema based on the specified operations.

The following detailed description and accompanying drawings provide a better understanding of the nature and advantages of the present invention.

### BRIEF DESCRIPTION OF THE DRAWINGS

FIG. 1 illustrates prior art transformation of XML documents.

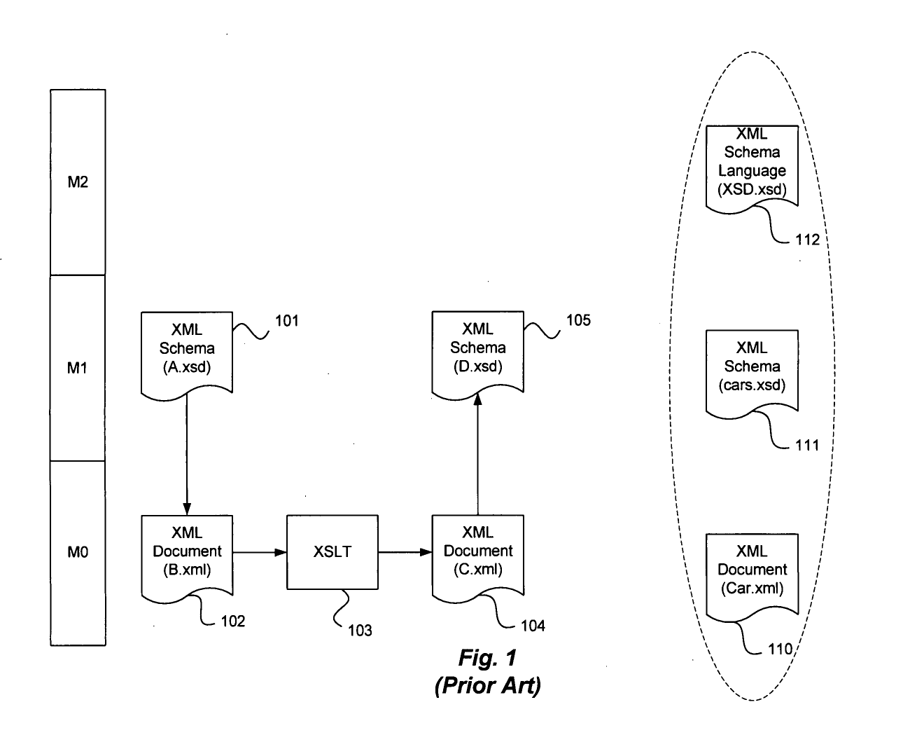

FIG. 2 illustrates a method of translating schemas according to one embodiment of the present invention.

FIG. 3 illustrates XML schema translation according to embodiments of the present invention.

FIG. 4 is an example of schema translation according to one embodiment of the present invention.

FIG. 5 is an example computer system and network for implementing embodiments of the present invention.

### DETAILED DESCRIPTION

Described herein are techniques for translating XML schemas. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include obvious modifications and equivalents of the features and concepts described herein.

Embodiments of the present invention allow XML schemas to be translated into new XML schemas. For example, an XML Schema may be used to create a variety of types of XML documents. If a new schema is available, the old XML schema may be translated into a new XML schema for defining new XML documents conforming to the new schema. Embodiments of the present invention may include a mechanism for selecting or otherwise accessing constructs in source XML schema files (on level M1 rather than level M0 in the four layer specification). Embodiments may further include a mechanism for creating target XML schema files by performing translation operations specified by a user in a schema translation specification. A schema transform processor (i.e., a translation processor) may receive the schema transform specification (i.e., a translation specification) and the old XML schema file as inputs and generate the new XML schema file as an output, for example. An example schema translation processor is described below.

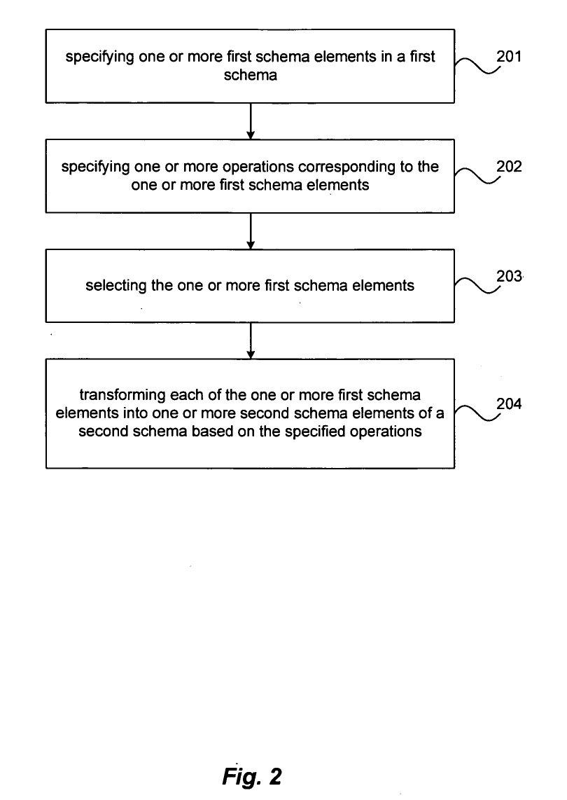

FIG. 2 illustrates a method of transforming schemas according to one embodiment of the present invention. At 201, one or more first schema elements, such as text or string patterns in an XML schema, may be specified. At 202, one or more operations corresponding to the one or more first schema elements are specified. At 203, the one or more first schema elements are selected. At 204, each of the one or more first schema elements are transformed into one or more second schema elements of a second schema (e.g., text or string patterns of a second XML schema) based on the specified operations.

In one embodiment, the present invention includes a high level schema transformation language (“HLSTL”). HLSTL may be used for creating a schema transform specification, for example. The schema transform specification may include HLSTL text that is read and used to select and transform XML schema files into new XML schemas.

The first step in the schema transform process may include selecting parts of the initial schema to be changed. As an example, the definition of the complex type “Buyer” in one XML schema may be changed to have another definition in a new XML schema. Selection can be achieved using the following HLSTL pseudo code:

<hlstl:template match=“complexType::Buyer”>
< hlstl:message>Found the buyer.</ htstl:message>
</ hlstl:template>

### The above pseudo code would select the underlined part of the following XML schema (XSD):

```
<xsd:complexType name=“Buyer”>
    <!-- ... -->
</xsd:complexType>
<xsd:element name=“Buyer”>
    <xsd:complexType>
        <!-- ... -->
    </xsd:complexType>
</xsd:element>
```

In this example, the anonymous complex type inside the defined element named “Buyer” (i.e., “<!-- . . . -->”) may not be selected by the pseudo code above. This anonymous type, for example, may be selected by selecting its surrounding element using the “element::name” pattern in the schema translation specification, for example. The following table illustrates a non-exhaustive list of example patterns that may be used in the schema translation specification to select elements from an XML schema in embodiments of the present invention.

| PATTERN | DESCRIPTION |
|---|---|
| complexType::name | Selects the complex type definition from |
| | the schema that is named name. |
| simpleType::name | Selects the simple type definition from the |
| | schema that is named name. |
| element::name | Selects the declaration of the element |
| | name |
| attribute::name | Selects the declaration of the attribute |
| | name. |
| complexTypeRef::name | Selects all references to the complex type |
| | named name. |
| simpleTypeRef::name | Selects all references to the simple type |
| | named name. |
| elementRef::name | Selects all references to the element |
| | named name. |
| attributeRef::name | Selects all references to the attribute |
| | named name. |

The next step in the schema transform process may include transforming the selected XML schema elements into new XML schema elements. The operations used in transformation process may be specified using HLSTL, for example. An example language translation specification may be of the form:

```
<hlstl:template match=”pattern::name”>
    <hlstl:operation1>
    <hlstl:operationN>
</hlstl:template>
```

Any number of operations may be specified. Operations may include multiple levels of children or parameters, for example, as illustrated below.

A simple operation implemented using a schema translation specification is the copy operation as shown in the following pseudo code example:

### HLSTL:

<hlstl:template match=“complexType::Buyer”>
<hlstl:copy/>
</hlstl:template>

### Old XML Schema:

```
<xsd:complexType name=“Buyer”>
  <xsd:sequence>
    <xsd:element ref=“Basket”>
  </xsd:sequence>
  <xsd:attribute name=“name” type=“xs:string”>
</xsd:complexType>
```

### New XML Schema:

```
<xsd:complexType name=“Buyer”>
    <xsd:sequence>
        <xsd:element ref=“Basket”>
    </xsd:sequence>
    <xsd:attribute name=“name” type=“xs:string”>
</xsd:complexType>
```

Any number of special operations may be included in schema translation specification. The usability of the elements depends on the element currently selected in the source XML schema file. The following illustrates setting default values in a new XML schema file based on an XML schema that does not include default values. Assuming a schema that defines an attribute “name” that is of type “xsd: string” and has no default value, the default value of the attribute could be altered to be “0” as follows:

### HLSTL:

```
< hlstl:template match=“attribute::name”>
    <hlstl:copy>
        <htstl:set default=“0”/>
    </hlstl:copy>
</ hlstl:template>
```

### Old XML Schema:

<xsd:attribute name=“name” type=“xs:string”>

### New XML Schema:

<xsd:atrribute name=¢name” type=“xs:string” default=“0”>

As another example, the content model of a complex type definition may be changed as shown below:

### HLSTL:

```
<hlstl:template match=“complexType::Buyer”>
  <hlstl:copy>
    <hlstl:insert after=“sequence/Basket”>
      < xsd:element ref=“InvoiceAddress”/>
    </hlstl:insert>
  </hlstl:copy>
</hlstl:template>
```

### Old XML Schema:

```
<xsd:complexType name=“Buyer”>
  <xsd:sequence>
    <xsd:element ref=“Basket”>
  </xsd:sequence>
  <xsd:attribute name=“name” type=“xs:string”>
</xsd:complexType>
```

### New XML Schema:

```
<xsd:complexType name=“Buyer”>
    <xsd:sequence>
        <xsd:element ref=“Basket”>
        <xsd:element ref=“InvoiceAddress”>
    </xsd:sequence>
    <xsd:attribute name=“name” type=“xs:string”>
</xsd:complexType>
```

As another example, a type definition may be recreated as shown below:

### HLSTL:

```
< hlstl:template match=“complexType::Buyer”>
  <xsd:choice>
    <xsd:element ref=“Basket”/>
    <xsd:element ref=“Order”/>
  </xsd:choice>
  <xsd:attribute name=“name” type=“xs:string”>
</hlstl:template>
```

### OLD XML SCHEMA:

```
<xsd:complexType name=“Buyer”>
  <xsd:sequence>
    <xsd:element ref=“Basket”>
  </xsd:sequence>
  <xsd:attribute name=“id” type=“xs:int”>
</xsd:complexType>
```

### NEW XML SCHEME:

```
<xsd:complexType name=“Buyer”>
  <xsd:choice>
    <xsd:element ref=“Basket”/>
    <xsd:element ref=“Order”/>
  </xsd: choice>
  <xs:attribute name=“name” type=“xs:string”>
</xs:complexType>
```

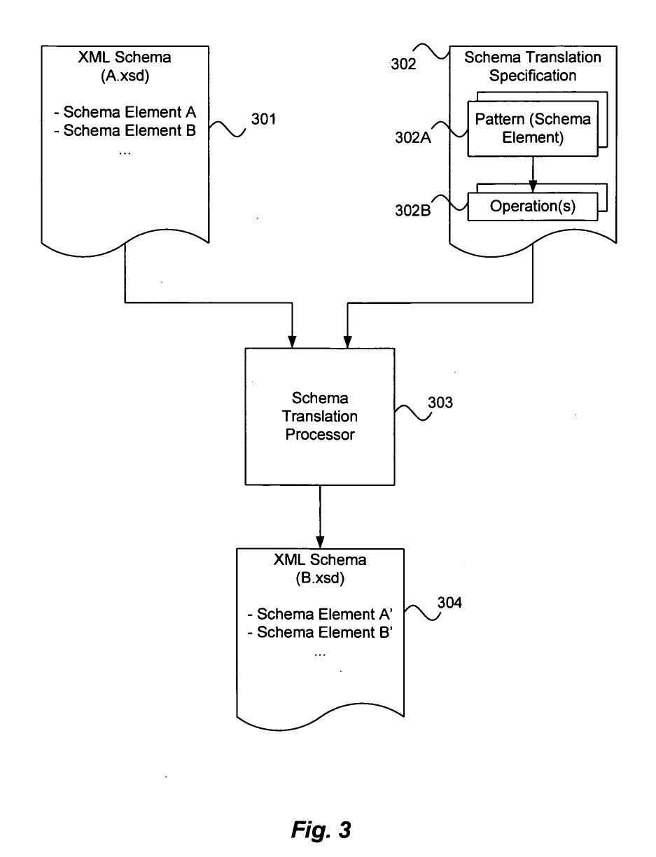

From the above examples, those skilled in the art will recognize that a variety of operations may be performed to translate one XML schema into another XML schema. FIG. 3 illustrates XML schema translation according to embodiments of the present invention. In one embodiment, a first schema 301 may include one or more schema elements A, B, etc. . . . , which may be any type of schema element such as type definitions, attributes, content models. In this embodiment, the initial XML schema is in a file “A.xsd,” for example. Schema elements in one schema may be translated (i.e., transformed) into elements in another schema by specifying particular elements to be selected and operations to be performed on the selected elements. The operations translate the source schema elements into new schema elements in a target schema, which may be stored in a file “B.xsd,” for example. A schema translation specification 302 may be used to store the information regarding what to select and how to transform the selected elements. The schema translation specification 302 may be specified using a HLSTL, for example. In this example, the schema translation specification 302 may include one or more patterns 302A for specifying particular schema elements to be selected from a schema. Each of the elements may be associated with one or more operations 302B. Operations may add, delete, modify, or copy elements as one schema is translated into another schema. Multiple schema elements may be specified for selection and translation in schema translation specification 302, and each element may include one or more operations.

A first schema may be used to generate second schema by providing the first schema (e.g., A.xsd) and the schema translation specification 302 to a translation processor (or transform processor) 303. Schema translation processor 303 may be implemented as a software program, for example. Schema translation processor 303 reads the schema translation specification 302 and schema 301, and selects the schema elements in the first schema 301 as specified in the schema translation specification 302. Processor 303 may read text or string patterns and perform selections and operations. For instance, if schema translation specification 302 includes a pattern that specifies schema element A for selection, then translation processor 303 will select instances of schema element A that are in A.xsd. Translation processor 303 will then implement the specified operations associated with the particular pattern specifying each schema element. For example, if schema element A is selected, translation processor 303 may translate schema element A into schema element A′ in schema 304 (e.g., B.xsd). Similarly, schema translation specification 302 may include a pattern to specify schema language element B for selection, and the pattern may have an associated operation to be performed on element B that translates element B into element B′. Accordingly, translation processor 303 may select element B in schema 301 and translate element B into element B′ in schema language 304.

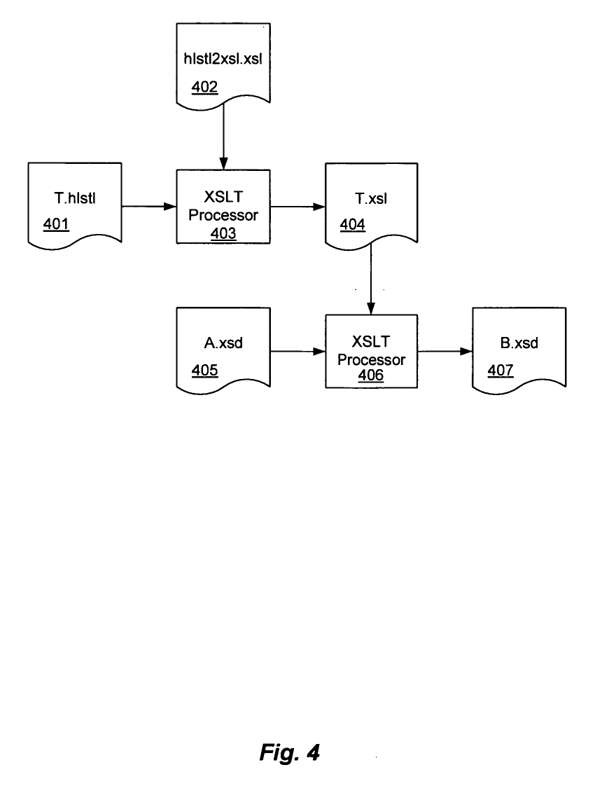

In one embodiment, XML may be used to define both a schema translation specification and a specification for transforming the schema translation specification into a XSLT format (T.xsl), thereby providing implementation of the above techniques on existing XSLT processors. FIG. 4 is an example of schema translation according to one embodiment of the present invention. In this example, implementation of a translation processor (e.g., for reading HLSTL) may use XSLT processing engines 403 and 406. In this example, a first processor 403 receives a schema translation specification 401 (T.hlstl) and an XSLT specification 402 for translating HLSTL into XSLT (hlstl2xsl.xsl). XSLT processor 403 generates a representation of the HLSTL specification in XSLT 404 (T.xsl). By transforming the HLSTL specification into an XSLT specification, a first schema 405 (A.xsd) may be translated into another schema 406 (B.xsd) using a XSLT processor 406. Since the transformation of the new schema patterns (like complexType::name) may require many string transformations, which is not a natural strength of XSLT, it may be desirable to use an extension mechanism that is offered by most XSLT processors in order to allow comfortable transformation of these patterns.

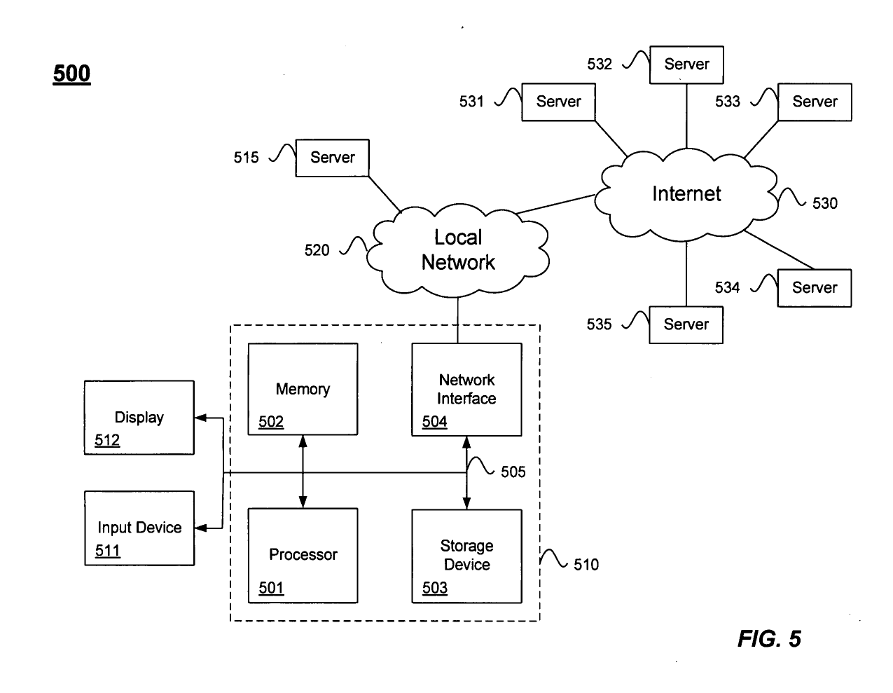

FIG. 5 illustrates an example computer system coupled to a network that may be used to implement the present invention. Computer system 510 includes a bus 505 or other communication mechanism for communicating information, and a processor 501 coupled with bus 505 for processing information. Computer system 510 also includes a memory 502 coupled to bus 505 for storing information and instructions to be executed by processor 501, including information and instructions for performing the techniques described above, including XML schemas, translation specifications, and translation processor instructions, for example. This memory may also be used for storing temporary variables or other intermediate information during execution of instructions to be executed by processor 501. Possible implementations of this memory may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 503 may include source code, binary code, or software files for performing the techniques or embodying the constructs above, for example.

Computer system 510 may be coupled via bus 505 to a display 512, such as a cathode ray tube (CRT) or liquid crystal display (LCD), for displaying information to a computer user. An input device 511 such as a keyboard and/or mouse is coupled to bus 505 for communicating information and command selections from the user to processor 501. The combination of these components allows the user to communicate with the system. In some systems, bus 505 may be divided into multiple specialized buses.

Computer system 510 also includes a network interface 504 coupled with bus 505. Network interface 504 may provide two-way data communication between computer system 510 and the local network 520. The network interface 504 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 504 sends and receives electrical, electromagnetic, or optical signals that carry digital data streams representing various types of information.

Computer system 510 can send and receive information, including messages or other interface actions, through the network interface 504 to an Intranet or the Internet 530. In the Internet example, software components or services may reside on multiple different computer systems 510 or servers 531-535 across the network. Translation processors described above may be implemented on one or more servers, for example. A server 531 may transmit actions or messages from one component, through Internet 530, local network 520, and network interface 504 to a component on computer system 510. Translation processing may be implemented on any computer system and receive schemas and/or schema translation specifications across a network, for example. In one embodiment, translation processing may be implemented as a software service by one or more servers 531-535, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims. The terms and expressions that have been employed here are used to describe the various embodiments and examples. These terms and expressions are not to be construed as excluding equivalent terms or equivalent processes, systems, or configurations of the features shown and described, or portions thereof, it being recognized that various modifications are possible within the scope of the appended claims.

What is claimed is:

1. A computer-implemented method of translating schemas comprising:
specifying one or more first schema elements in a first schema;
specifying one or more operations corresponding to the one or more first schema elements;
selecting the one or more first schema elements; and
transforming each of the one or more first schema elements into one or more second schema elements of a second schema based on the specified operations.

2. The method of claim 1 wherein the first schema elements are string patterns in an XML schema language.

3. The method of claim 1 wherein the operations are specified using string patterns.

4. The method of claim 1 wherein the first schema elements and operations are specified in a first schema translation specification.

5. The method of claim 4 further comprising transforming the first schema translation specification into a second schema translation specification.

6. The method of claim 5 wherein the first schema translation specification is transformed into the second schema translation specification using an XSLT processor and an XSLT specification, and wherein the second schema translation specification is an XSLT specification used for transforming the first schema elements into the second schema elements.

7. A computer system including software for translating schemas, the software comprising:
a first schema software file comprising a plurality of schema elements;
a first schema translation specification software file comprising one or more schema elements to be selected, wherein each schema element to be selected has one or more associated operations; and
a translation processor for receiving the first schema, the translation processor translating the first schema in accordance with the first schema translation specification,
wherein the translation processor selects one or more schema elements in the first schema and transforms the selected schema elements.

8. The computer system of claim 7 wherein the translation processor generates a second schema software file.

9. The computer system of claim 8 wherein the first and second schemas are XML schema languages.

10. The computer system of claim 7 wherein the plurality of schema elements in the first schema are string patterns in an XML schema language.

11. The computer system of claim 7 wherein the operations are specified using string patterns.

12. The computer system of claim 7 further comprising a second schema translation specification software file, wherein the first schema translation specification is transformed into the second schema translation specification software file.

13. The computer system of claim 12 wherein the first schema translation specification is transformed into the second schema translation specification using an XSLT processor and an XSLT specification, and wherein the second schema translation specification is an XSLT specification used for transforming the selected schema elements into second schema elements.

14. A computer-readable medium containing instructions for controlling a computer system to perform a method of translating schemas, the method comprising:
specifying one or more first schema elements in a first schema;
specifying one or more operations corresponding to the one or more first schema elements;
selecting the one or more first schema elements; and
transforming each of the one or more first schema elements into one or more second schema elements of a second schema based on the specified operations.

15. The computer-readable medium of claim 14 wherein first schema elements are string patterns in an XML schema language.

16. The computer-readable medium of claim 14 wherein the operations are specified using string patterns.

17. The computer-readable medium of claim 14 wherein the first schema elements and operations are specified in a first schema translation specification.

18. The computer-readable medium of claim 17 further comprising transforming the first schema translation specification into a second schema translation specification.

19. The computer-readable medium of claim 18 wherein the first schema translation specification is transformed into a second schema translation specification using an XSLT processor and an XSLT specification, and wherein the second schema translation specification is an XSLT specification used for transforming the first schema elements into the second schema elements.

20. A computer system including software for translating schemas, the software comprising:
means for specifying a first schema;
means for specifying a first schema translation specification; and
means for transforming the first schema into a second schema based on the first schema translation specification.

21. A method of translating schemas comprising:
a step for specifying one or more operations corresponding to the one or more first schema elements;
a step for selecting the one or more first schema elements; and
a step for transforming each of the one or more first schema elements into one or more second schema elements of a second schema based on the specified operations.
